(19) United States
(12) Patent Application Publication
(10) Pub. No.: US 2008/0074383 A1
(43) Pub. Date: Mar. 27, 2008

(54) Portable electronic device having appearance customizable housing

(76) Inventor: Kenneth A. Dean, Phoenix, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/529,013

(22) Filed: Sep. 27, 2006

(51) Int. Cl. G09G 5/00

(52) U.S. Cl. 345/156

(57) ABSTRACT

A portable electronics device (110) is provided having a thin, low power color and pattern customizable housing surface (118, 120, 122) wherein the color and/or pattern can be configured at anytime to any color. The portable electronics device (110) comprises a skin (200) positioned on the surface, wherein the skin (200) includes a first plurality of layers (202, 302, 406) for selectively reflecting a first color, a second plurality of layers (204, 304, 404) for selectively reflecting a second color; and a third plurality of layers (206, 306, 402) for selectively reflecting a third color. Circuitry is positioned within the housing for receiving and storing at least one appearance feature, and for selecting one of the at least one appearance feature for presentation by the skin.

### FIELD OF THE INVENTION

The present invention generally relates to portable electronic devices and more particularly to a portable electronic device having a color and pattern customizable housing surface.

### BACKGROUND OF THE INVENTION

The market for personal portable electronic devices, for example, cell phones, personal digital assistants (PDA's), digital cameras, and music playback devices (MP3), is very competitive. Manufacturers, distributors, service providers, and third party providers have all attempted to find features that appeal to the consumer. For example, service providers are continually looking to improve cell phone reception and access to the internet for down loading of information, music, and the like. Third party providers are constantly searching for the additional item that functions well with the manufacture's product. Manufactures are constantly improving their product with each model in the hopes it will appeal to the consumer more than a competitor's product. Many times these manufacture's improvements do not relate directly to the functionality of the product.

The look and feel of personal portable electronics devices is now a key product differentiator and one of the most significant reasons that consumers choose specific models. From a business standpoint, these outstanding designs (form and appearance) increase market share and margin.

Consumers are enamored with sleek designs and other customizable features, e.g., cell phone ring tones, on portable electronic devices. These features reflect personal style. Consumers select them for some of the same reasons that they select clothing styles, clothing colors, and fashion accessories. These two worlds have not merged because consumers have multiple sets of clothing and generally only one personal electronic device (perhaps of each type), and this device has a single defined color. In short, consumers have a very limited ability to match colors and patterns of personal electronics devices to their clothing, their accessories, their car, or their mood. Plastic snap-on covers for devices such as cell phones and MP3 players can be purchased in pre-defined patterns and colors. These snap-on covers are quite popular, and yet they provide a very limited customization capability.

The idea of electronically changing the color of electronics is known in the art. European Patent Publication Number 0564127 A2 describes a telephone housing (a land-line and a wrist watch band), which changed color to indicate receipt of information. Electrochromic and liquid crystal displays are mentioned as options. However, the important issues (low power, high reflectivity, wide color gamut, low cost, mechanical robustness, and thin, conformable geometries) for a portable electronics device which can match the color of an existing object are not considered. For example, electrochromic technology has an insufficient color gamut, and color liquid crystal displays are not reflective enough. And neither are low power options.

U.S. Pat. No. 6,924,792 presents the idea of using electrowetting lenses to change the color of a cellular phone. This art uses the electrowetting technology to form electronically controlled lenses. This scheme results in low reflectivity, the inability to mix colors, and suffers from objectionable layer thickness. The inability to mix a wide range of colors means that colors of existing objects cannot be matched.

U.S. Published Patent Application 2003/0160741 A1 describes a cell phone housing that changes color in response to variable electrical input and includes a menu with selectable colors. This patent teaches the use of electrochromic technology, which is available in very limited colors and has a stability problem over time. Electrochromic technology cannot provide the reflectivity or color gamut needed to match the existing colors of wearable objects.

In prior art, the use of bi-color shutter technology (e-ink) has been described to change the look of a portable electronics device. This shutter layer was described on a thin, flexible substrates, which is suitable for a ‘skin’ application. However, the idea of color matching requiring high reflectivity, wide color gamut, and low power has not been addressed.

There is clearly a need for a better solution: a need for a technology that will allow consumers to easily and conveniently match the color and pattern of their portable electronics devices to both their moods and wearable items.

Accordingly, it is desirable to provide a portable electronics device having a thin, low power color and pattern customizable housing surface wherein the color and/or pattern can be configured at anytime to any color. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A portable electronics device having a thin, low power color and pattern customizable housing surface is provided, wherein the color and/or pattern can be configured at anytime to any color. The portable electronic device includes a housing having a surface. Circuitry positioned within the housing receives and stores at least one color. An interface allows for selection of one of the at least one color. A skin having a white reflectivity of less than 30% is positioned on the surface, and comprises a plurality of layers for reflecting a plurality of colors for presenting the selected at least one color.

### BRIEF DESCRIPTION OF THE DRAWINGS

The present invention will hereinafter be described in conjunction with the following drawing figures, wherein like numerals denote like elements, and

FIG. 1 is a front view of a portable electronic device encased in an exemplary embodiment;

FIG. 2 is a partial cross section of a first exemplary embodiment;

FIG. 3 is a partial cross section of a second exemplary embodiment;

FIG. 4 is a partial cross section of a third exemplary embodiment; and

FIG. 5 is a block diagram illustrating circuitry for implementing various exemplary embodiments on the portable electronic device of FIG. 1.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The exemplary embodiment described herein gives the consumer control over the colors and/or patterns of their portable electronics devices. For electronics devices, the preferred approach is a ‘skin’ (visible surface) which changes colors and patterns in response to electronics signals. This enables consumers to change the colors and patterns multiple times per day. The color and pattern the skin is to assume may be determined or acquired by one of several methods. A color and/or pattern may be stored in memory and selected by the consumer or may be determined by the consumer by adjusting input devices, e.g., potentiometer knobs. The color and pattern may be acquired by a camera, e.g., integral to the portable electronic device or may be provided with an incoming signal (determined by the source of the call). The status of the phone, e.g., silent alert, may dictate the color and pattern, and a sensor may be provided to detect incident light spectrum for better color rendition.

There are several attributes of this skin that directly follow from its ability to match the color of a portable electronic device to an existing color. The skin displays the desired color and pattern without consuming a significant amount of power from the portable electronics device, so that the device does not lose its ability to perform its original functionality. The power consumption of the skin in the exemplary embodiment is less than 40% of the battery capacity per day, and preferably less than 20% of the battery capacity per day. A low power reflective skin technology is preferred over a higher power emissive technology because of the lower drain on the battery.

The skin is very thin so that the portable electronics device retains its small, portable form-factor. The skin technology (which might include a protective overlayer) is mechanically robust, since it will be on the outer surface of portable devices that often receive a great deal of handling and abuse. And since cost is a key driver of portable electronics device fabrication, the ‘skin’ technology is extremely low cost. The skin will be less expensive than if the entire housing were made from a suitable information display. For example, a full color, high resolution LCD scaled to the full size of the portable electronics device would be able to change colors and patterns, though it should be noted that traditional LCD video displays cannot deliver the required reflectivity for a skin in order to produce vivid colors with low power consumption. The ‘skin’ and drivers can be made substantially less expensive than a full-resolution LCD by reducing the number of inputs and drivers, allowing for the depiction of colors and simple patterns, and small amounts of information. The skin and drivers would cost less than 30% of a traditional LCD and drivers. For fairly simple portable electronics devices, the skin and drivers cost should be less than half the cost of the power source (i.e. battery). In addition, for complex devices like cellular phones and video MP3 players, the ‘skin’ and drivers should be less expensive than the most expensive component, typically the power source, memory, or the main LCD display. For cellular phones, the cost of the skin and drivers conceivably would be less than ten 2006 U.S. dollars.

To match the colors of existing objects, the ‘skin’ has a similar reflectivity capability of existing objects. The reason is that matching a color is not simply a matter of matching the light wavelength emanating from an object. The shade is matched, and the shade is determined by the spectrum of light, as well as the intensity of the light. An object that reflects the same spectrum as another, but has ⅓ the intensity will appear as a darker shade, and it will not ‘match the color’ of the object. Clearly, to a consumer, ‘matching a color’ actually means matching a color shade. The skin is capable of displaying grayscales. In order to effectively match color shades, the ‘skin’ is capable of displaying a wide range of colors. The skin generates three well-saturated primary colors so that it can effectively mix them to display a wide range of shades. In the languages of display and printing technologies, the skin generates saturated red, green, and blue, or saturated cyan, magenta, and yellow. A saturated color means a color having a spectrum with a sharp peak at that color and a very low background of other colors. Ideally, a display would have a reflectivity greater than 40% of the SMPTE-C (Society of Motion Picture and Television Engineers) standard color gamut, as defined by x and y coordinates for each color on the 1931 Commission International De I'Eclairge chromaticity diagram: Xr=0.630 , Yr=0.340 , Xg=0.310 , Yg=0.595 , Xb=0.155 , and Yb=0.070.

Not surprisingly, the types of technologies that meet these attributes for an electronically controlled skin on portable devices are similar. In order to achieve good reflectivity, each primary color must be distributed over the entire skin surface. This is not achievable with most reflective display technologies, for example, standard liquid crystals, electrophoretic displays (e-ink, gyricon, SiPix, Bridgestone), electrochromic displays (NTERA), and microelectromechanical displays (IMOD), which pattern lateral regions of the primary colors. These reflective technologies theoretically reflect less than 33% of the incident primary light, wherein a color piece of clothing theoretically reflects 100%. These displays practically reflect less than 30% of the incident light due to inefficiencies such as the separation between lateral pixels, or index-matching losses. The exemplary embodiment overcomes this problem by distributing the primary colors in the skin as layers. Thus, each color occupies the entire surface. This is accomplished by each layer of the ‘skin’ acting as a colored shutter. The ‘open’ condition of the shutter is transparent (not black or white) so that the underlying colors are visible when the first color is “off”. Two low cost display-like technologies, electrowetting light valves and cholesteric liquid crystals, may be used to produce stacked colored shutters. Typical electrowetting uses a voltage to change the wetting properties of a drop of colored oil in water, thereby moving the colored oil like a shutter in and out of view. Typical electrowetting schemes use absorptive oils of Cyan, Magenta, and Yellow for the highest efficiency subtractive approach.

In contrast, cholesteric liquid crystal technology uses a liquid crystal with well defined lattice spacings which reflect light. Each shutter (of three stacked shutters) is reflective for a specific color in the closed state and transparent in the open state. Cholesteric LCD technology can achieve average reflectivities over all the visible spectrum of greater than 30% for the three layer stack. Cholesteric LCDs are completely bi-stable, meaning that they consume no power to display a color after it is established. Both electrowetting and cholesteric technologies use low cost materials and low cost driving methods.

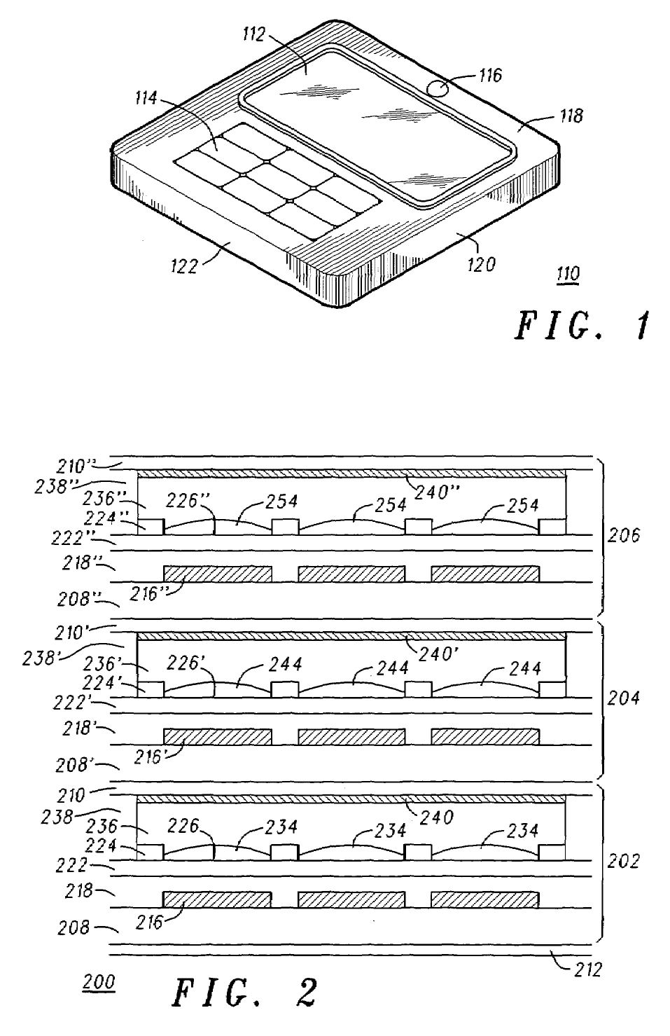

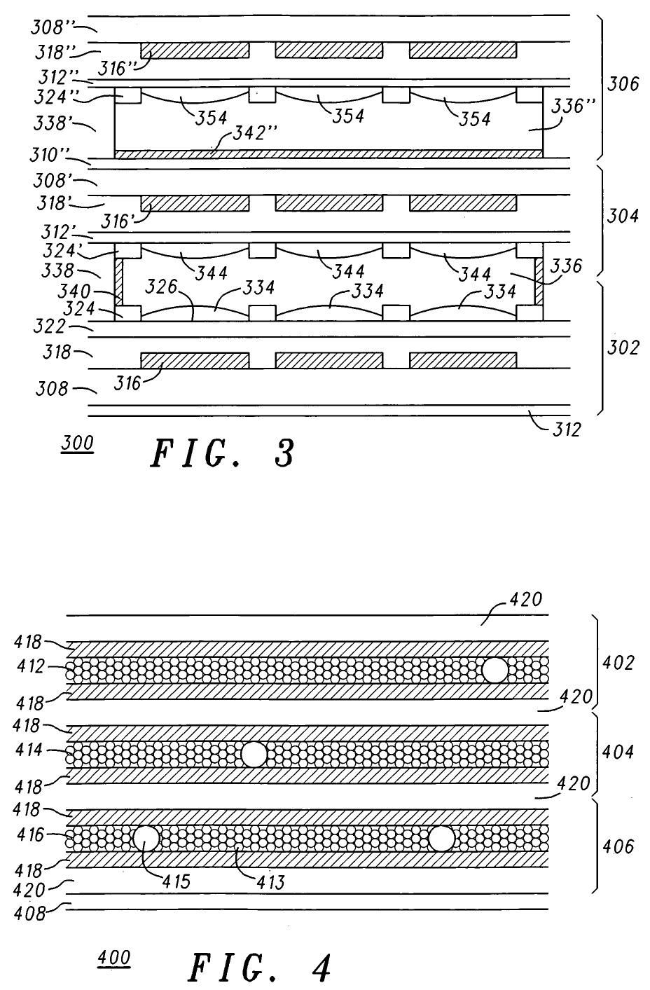

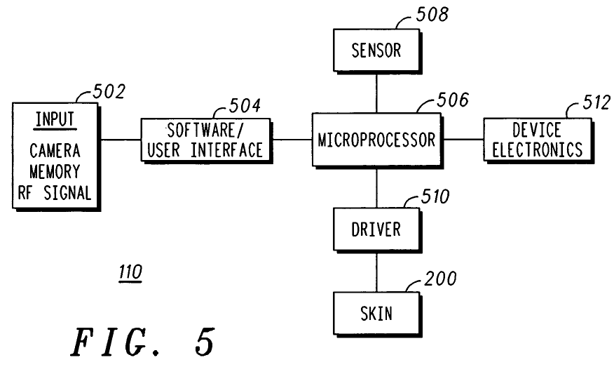

Referring to FIG. 1, an exemplary embodiment of a portable electronic device 110 comprises a display 112, a control panel 114, and a camera lens 116. Some portable electronic devices 110 may include other elements such as an antenna and a microphone. The portable electronic device 110, in accordance with the exemplary embodiment as shown, comprises an outer “skin” on the front surface 118, side surface 120, and bottom surface 122. The skin may cover one or a multiple of surfaces of the portable electronic device 110. In first and second exemplary embodiments (FIGS. 2 and 3), the skin comprises a electrowetting technology and in a third embodiment (FIG. 4) the skin comprises a cholesteric liquid crystal technology.

Electrowetting technology, a preferred approach, uses a colored shutter (color by absorption rather than reflection), which allows layers to be stacked to form an efficient reflective surface. The “open shutter” transmissivity may exceed 80 to 90%. Referring to FIG. 2, a skin 200 comprises three tiers 202, 204, 206. Each tier is an independent color cell, and these tiers 202, 204, 206 are fastened together. One method of fastening is an index-matched optical adhesive. Each tier 202, 204, 206 contains a top substrate 210, 210′, 210″, respectively, and a bottom substrate 208, 208′, 208″, respectively. Similar elements are identified with a number in tier 202, a prime of the number in the tier 204, and a double prime in the tier 206. In the preferred embodiment, all six substrate layers 208, 210, 208′, 210′, 208″, 210″ are formed of a transparent, sturdy, thin material such as glass, but preferably would comprise a flexible polymer such as polyethylene terephthalate (PET) or polyethylene naphthalate (PEN). A flexible substrate would be desired when the skin is to “bend” around corners or curves in the portable electronic device 110 housing. Perhaps more importantly, flexible substrates are robust, and 12 micrometer to 300 micrometer thick substrates are commonly used for electronics devices. In contrast, glass materials are too fragile at these thicknesses. When three to six flexible substrates are stacked together, the resulting overall thickness is less than approximately 1 mm, which is suitable for portable electronics devices. A white reflective backplane 212 is positioned at the bottom of the substrate 208. Alternatively, the bottom substrate 208 of tier 202 may be replaced with a compatible white substrate, thereby omitting the bottom layer 212. The tier 202 comprises transparent conductor 216, for example, indium tin oxide (ITO) or poly-3,4-ethylenedioxthiophene (PEDOT), deposited on substrate 208. An optional insulator material 218 is deposited over the conductor 216 and substrate 208. A layer 222 of a hydrophobic (insulator) film is formed on the optional insulator material 218 (or the oxide 214 and conductor 216). The layer 22 comprises, for example, fluoropolymers and parylene. A hydrophobic material 224 is patterned on the surface 226 of the layer 222 to establish an operating element size. The pattern of the hydrophobic material 224 preferably forms a grid of ribs which creates an array of cells, 232, but may take any form. In a preferred embodiment, the grid is formed from polymethyl methacrylate (PMMA) or a photoresist such as epoxy-based SU8 from Microchem. A first oil 234 is placed on the surface 226 of the hydrophobic material 224 within the voids 232. The first oil 234 comprises, for example, a mineral oil containing pigments which are soluble in oil, but not water. Example pigments or chromophores are lithol rubine (Red), B: copper thalocyanine (Blue), diarylide yellow (Yellow) at 4 weight percent concentration. The rest of the cell is filled with a fluid that does not mix with oil, for example, water. The fluid 236 may contain surfactants and other elements to extend the temperature range of the fluid, aid manufacturing, and improve oil repulsion. The fluid 236 is placed on the first oil 234 and sealed in place by the combination of the seal 238 and the substrate 210. An electrode 240 comprising a transparent conductive material such as indium tin oxide is formed on the substrate 210 for contacting the fluid 236. In another embodiment, this electrode 240 may be patterned, for example, to include bus lines.

The second tier 204 and third tier 206 are fabricated similar to the first tier 202, with like elements represented by the same number, except those in the second tier 204 are identified with a single prime (′) and those in the third tier 206 are identified with a double prime (″). A difference in the tiers 202, 204, 206 is that the second tier 204 comprises a second oil 244 and the third tier 206 comprises a third oil 254. Though the color of the oils 234, 244, 254 in the tiers 202, 204, 206 may be in any order, preferably the first, second, and third oils 234, 244, 254 comprise red, blue, and green, or cyan, magenta, and yellow.

For displaying a simple color, an electrical connection is needed for the ground planes in each cell, and for the three color layers. The entire skin functions as a single pixel. An additional embodiment of this invention is to display patterns. The skin surface can be subdivided into regions with various shapes to permit different areas to display different colors. The additional electrical connections require additional interconnects and driving electronics. Example shapes could include flames, highlights, circles, and hearts. These patterns can reside within a color layer, so that a uniform red ‘skin’ could be switched to display a flame pattern. These patterns can also reside on a forth layer of material which would modulate the intensity of all three colors. This fourth layer may comprise an emissive technology, for example, a pattern illuminated by light emitting diodes. In additional embodiments, more interconnects can be added to subdivide the skin into many more regions. In this case, simple patterns could be displayed including check boards, grids, and plaids, potentially using multiple colors.

In operation, when a desired color and/or pattern is determined (as discussed hereinafter), signals are sent to each tier 202, 204, 206 to move none, one, two, or three of the oils 234, 244, 254. When one of the oils, e.g., 234, is selected to open, the voltage applied across the tier 202 causes the oil to withdraw to a corner of its void 232, allowing light to bypass the oil 234. Therefore, by applying the proper signals to each of the tiers 202, 204, 206, the desired color is achieved.

A second exemplary electrowetting technology embodiment of a skin 300 for a portable electronic device 110 is shown in FIG. 3 wherein elements similar to those of FIG. 2 comprise similar material composition. A skin 300 comprises three tiers 302, 304, 306, except the second and third tiers 306, 308 are inverted from those of the exemplary embodiment of FIG. 2 to reduce the number of layers, the number of process steps, the overall thickness, and the optical efficiency. The tier 302 is formed between the substrate 308 and the second tier 304, the tier 304 is formed between the tier 302 and the substrate 310′, and the tier 306 is formed between the substrate 310′and 310″. A white reflective backplane 312 is positioned at the bottom of the substrate 308. Alternatively, the bottom substrate 308 of tier 302 may be replaced with a compatible white substrate, thereby omitting the bottom layer 312. The tier 302 comprises an oxide 314 patterned for depositing on the substrate 302 a transparent conductor 316, for example, indium tin oxide (ITO) or poly-3,4-ethylenedioxthiophene (PEDOT). An optional insulator material 318 is deposited on the oxide 314 and conductor 316. A layer 322 of a hydrophobic (insulator) film is formed on the optional insulator material 318 (or alternatively on the oxide 314 and conductor 316). A hydrophobic material 324 is patterned on the surface 326 of the layer 322 to define cells 232. The pattern of the hydrophobic material 224 preferably forms a grid, creating an array of cells 232, but may take any form. A first oil 234 is placed on the surface 326 of the hydrophobic material 324 within the voids 332. The hydrophobic material comprises, for example, SU8 photoresist, that repulses the fluid 336. The fluid 334 is placed on the first oil 334 and sealed in place by the combination of the seal 338 and the substrate 310. An electrode 340 comprising a transparent conductive material such as indium tin oxide is formed on the seal 338 for contacting the fluid 336.

The second tier 304 and third tier 306 are fabricated similar to the first tier 302 but inverted to that of the first tier 302, with like elements represented by the same number, except those in the second tier 304 are identified with a single prime (′) and those in the third tier 306 are identified with a double prime (″). A difference in the tiers 302, 304, 306 is that the second tier 304 comprises a second oil 344 and the third tier 306 comprises a third oil 354. Though the color of the oils 334, 344, 354 in the tiers 302, 304, 306 may be in any order, preferably the first, second, and third oils 334, 344, 354, respectively, comprise red, blue, and green, , or cyan, magenta, and yellow. An electrode 342″ is provided for coupling to the fluid 336″.

In operation, without voltage applied, three layers of absorptive oils are located in the optical path, and the display looks black (for the cyna-magenta-yellow subtractive approach). By applying voltages to the layers (typically <40 V), the colored oil moves to the side of each cell, eliminating the absorption of specific wavelengths. Incident light then bounces off the backplane and back to the viewer. The amount of displacement of the colored oil is correlated to the applied voltage. Consequently, different shades of colors (greyscales) are obtained by modulating the applied voltage level. The color is maintained by continual application of applied voltage. However, the leakage current is tremendously small, and colors can be maintained for minutes after a voltage source is disconnected. In a preferred embodiment, voltage levels are applied to the display once to set the desired color, and then they are re-applied at intervals (for example, 2 minutes), to refresh the charge.

As an alternative to the electrowetting technology, cholesteric liquid crystal technology may be used as a skin 200 on the portable electronic device 110. Reflective liquid crystal technology is preferred over transmissive liquid crystal technology for portable applications due to reduced power consumption, even though contrast is reduced by having light pass twice through the skin 200. The reflective liquid crystal skin 200 is thinner than 1 mm, and comprises stacked colored layers positioned on top of a light absorber, for example, black pigment. Referring to FIG. 4, first, second, and third stacked layers 402, 404, 406 are positioned above a layer of black material 408. Each of the stacked layers 402, 404, 406 comprise a layer 412, 414, 416 of cholesteric liquid crystal positioned between conductive transparent layers 418. Examples of transparent conductors include indium tin oxide (ITO) and PEDOT (poly-3,4-ethylenedioxthiophene, for example). The cholesteric liquid crystal material is preferably polymer-microencapsulated to form small balls 413 (<10 um in diameter). This eliminates the pressure sensitivity of the liquid crystal material and allows for simple deposition processing. Non-active spacers 415 are often mixed with the liquid crystal material to maintain the gap between substrates. Transparent substrates 420 separate, and are positioned above and below, the stacked layers 402, 404, 406. The transparent substrates preferably would comprise a flexible polymer such as polyethylene terephthalate (PET) or polyethylene naphthalate (PEN). A flexible substrate would be desired when the skin is to “bend” around corners or curves in the portable electronic device 110 housing. Perhaps more importantly, robust flexible substrates in the thickness ranges of 12 micrometer to 300 micrometer thick are commonly available, allowing the overall device thickness to be less than 1 mm, with four to six stacked substrates.

The cholesteric liquid crystal material typically exists in three states, a focal conic state, a homeotropic state, and a planar state. The focal conic state and the homeotropic state are transparent, while the planar state is colored. To switch from one color to another, the voltage is typically driven to a mid-range voltage (homeotropic state), which effectively erases the previous color. Then a higher voltage is applied to drive the device back into the planar state. The degree of transition to the planar state is a function of the applied voltage above the threshold field for the planar state. The degree of transistion can be modulated to achieve greyscales and shades. Lower voltages leave the device in the focal conic state, resulting in transparency. A very important feature of cholesteric LCDs is that they require zero power to maintain a color shade, once established.

In another embodiment of the cholesteric skin, each substrate between the cholesteric liquid crystal layers 412, 414, 416 may comprise two substrates joined together. In still another embodiment, the black layer 408 may be omitted from a region. A forth layer, such as an emissive display, might be positioned under this omitted area. When the overlying cholesteric LCD is driven to a transparent state, the display can be viewed underneath the skin. When the emissive display is off, it will be nearly black to provide proper color rendition from the skin in that area.

A block diagram of the portable electronic device 110 is shown in FIG. 5 and comprises an input 502 that may comprise one or more of several types of inputs. For example, the input 502 may comprise a camera integrated within the portable electronic device 110, circuitry for receiving RF data, or a memory for storing data. The data is forwarded to a software/user interface 504 wherein the user of the portable electronic device 110 is able to choose the desired color for output to the skin. The data is then sent to the microprocessor 506 which is coupled to each of a sensor 508, the skin driver 510, and device electronics 512. The sensor 508 provides information about background lighting to the microprocessor 506. Information about the desired appearance feature (color and/or pattern) is forwarded to the driver 510 which is electrical circuitry that drives the skin 200. Device electronics 512 comprises other circuitry that provides functionality to the portable electronic device 110. For example, in the case of a cell phone, device electronics 512 may include an antenna, circuitry for receiving and conversion of RF signals, a display, speakers, etc.

The selection, or determination, of the color and/or pattern may be made in several ways. A first exemplary method is to store a plurality of colors and patterns in the memory 404, with the desired color and/or pattern selected by the user of the portable electronic device 110 by operation of the control panel 114. The plurality of colors and patterns may be stored in the memory 404 at the time of manufacture or entered later by the user. A second exemplary method comprises the color or pattern arriving electronically, such as with an incoming call on a cell phone. For example, a daughter's incoming call may cause the phone to become pink, or a good friend may cause the phone to turn blue. A third exemplary method comprises taking a picture or image with a camera 410 (which optionally may be integrated within a cell phone). The microprocessor 402 processes that image and causes the skin 200 to assume that color and/or pattern. A fourth exemplary method comprises software in the microprocessor that allows the user to generate various colors and/or patterns by operation of the control panel 114.

When an input is received at the input 502, such as when a camera takes a picture, the software in the software/user interface 504 allows the user to select, e.g., put a cursor over, the desired color. The software gathers the color data from the pixel and pixels selected. It then drives the skin 200 to produce this color. The software will use look up calibration tables, which may be temperature compensated referenced to information received from the sensor 508, to properly render the color. It may also adjust the color rendition depending on the spectrum of incident light (sunlight, fluorescent, incandescent, using the sensor 508). It may adjust the color as the object moves between areas of different light sources.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A portable electronic device comprising:
a housing having a surface;
circuitry positioned within the housing for receiving and storing at least one color, and for selecting one of the at least one color and providing a signal representative of the selected color; and
a skin positioned on the surface and comprising a plurality of colored layers for reflecting a plurality of colors for presenting the selected at least one color in response to the signal, the skin having an average reflectivity in the visual spectrum of greater than 30%.

2. The portable electronic device of claim 1 wherein the source comprises a camera and the portable electronic device further comprises controls wherein a color may be selected from an acquired picture taken by the camera and displayed by the skin.

3. The portable electronic device of claim 1 further comprising controls for selecting the data from a plurality of data.

4. The portable electronic device of claim 1 wherein the skin comprises a plurality of layers less than 1 mm thick.

5. The portable electronic device of claim 1 wherein the skin comprises a plurality of layers utilizing an electrowetting technology.

6. The portable electronic device of claim 1 wherein the skin comprises a plurality of layers utilizing a cholesteric liquid crystal display technology.

7. The portable electronic device of claim 1 wherein the skin comprises a battery drain of less than 30 milliwatts per day.

8. The portable electronic device of claim 1 wherein the skin comprises a color gamut greater than 50% of the SMPTE-C standard.

9. The portable electronic device of claim 1 wherein the skin may be conformed to non-planar shapes.

10. The portable electronic device of claim 1 further comprising a sensor to detect the ambient illumination for adjustment of the shade of the selected color.

11. The portable electronic device of claim 1 wherein the skin comprises multiple addressable regions for displaying patterns.

12. The portable electronic device of claim 1 further comprising a transparent protective layer overlying the skin.

13. The portable electronic device of claim 1 wherein the manufacturing cost of the skin is less than half the cost of the power source.

14. The portable electronic device of claim 1 wherein the portable electronic device comprises a cellular telephone.

15. A portable electronic device having a surface, comprising:
a source of data defining at least one appearance feature;
a microprocessor for processing the source data and providing a signal representative of the at least one appearance feature; and
a skin positioned over the surface and responsive to the signal for displaying the at least one appearance feature,
wherein the skin uses less than 40% of the amount of power the portable electronic device's power source can provide in a day.

16. The portable electronic device of claim 15 wherein the source comprises a camera and the portable electronic device further comprises controls wherein the appearance feature comprises a color that may be selected from an acquired picture taken by the camera and displayed by the skin.

17. The portable electronic device of claim 15 further comprising controls for selecting the data from a plurality of data.

18. The portable electronic device of claim 15 wherein the skin reflects three colors having an average reflectivity in the visible spectrum greater than thirty percent.

19. The portable electronic device of claim 15 wherein the skin comprises a plurality of layers less than 1 mm thick.

20. The portable electronic device of claim 15 wherein the skin comprises a plurality of layers utilizing an electrowetting technology.

21. The portable electronic device of claim 15 wherein the skin comprises a plurality of layers utilizing a cholesteric liquid crystal display technology.

22. The portable electronic device of claim 15 wherein the skin comprises a battery drain of less than 30 milliwatts per day.

23. The portable electronic device of claim 15 wherein the skin may be conformed to non-planar shapes.

24. The portable electronic device of claim 15 wherein the skin comprises multiple addressable regions for displaying the at least one appearance feature as a pattern.

25. The portable electronic device of claim 15 wherein the manufacturing cost of the skin is less than half the cost of the power source.

26. The portable electronic device of claim 15 wherein the portable electronic device comprises a cellular telephone.

27. A portable electronic device comprising:
a housing having a surface:
a skin positioned on the surface and comprising:
a first plurality of layers for selectively reflecting a first color;
a second plurality of layers for selectively reflecting a second color; and
a third plurality of layers for selectively reflecting a third color;
a material formed between the skin and the surface, the material being either white or black in color; and
circuitry positioned within the housing for receiving and storing at least one appearance feature, and for selecting one of the at least one appearance feature for presentation by the skin.

28. The portable electronic device of claim 27 wherein the first, second, and third plurality of layers each comprise:
a first electrode;
a second electrode; and
an oil positioned between the first and second electrode, wherein light entering the skin passes through the oil when no voltage is applied to the first and second electrodes, and the oil migrates when a voltage is applied to the first and second electrodes with most of the light bypassing the oil.

29. The portable electronic device of claim 27 wherein the first, second, and third plurality of layers each comprise:
a first electrode;
a second electrode; and
a layer of cholesteric liquid crystal material positioned between the first and second electrode.
